(19) United States
(12) Patent Application Publication
(10) Pub. No.: US 2017/0052881 A1
(43) Pub. Date: Feb. 23, 2017

(54) TRACE INFORMATION MANAGEMENT SYSTEM, METHOD, AND PROGRAM PRODUCT

(71) Applicant: Kabushiki Kaisha Toshiba, Minato-ku (JP)

(72) Inventors: Nobuaki TOJO, Tachikawa (JP); Mayuko KOEZUKA, Ota (JP); Hidenori MATSUZAKI, Fuchu (JP); Akira KURODA, Yokohama (JP)

(73) Assignee: Kabushiki Kaisha Toshiba, Minato-ku (JP)

(21) Appl. No.: 15/234,408

(22) Filed: Aug. 11, 2016

(30) Foreign Application Priority Data
Aug. 20, 2015 (JP) 2015-162817

(51) Int. Cl. G06F 11/36

(52) U.S. Cl. CPC G06F 11/3672

(57) ABSTRACT

A trace information management system includes: an acquirer configured to acquire trace information indicating an execution sequence of a plurality of scopes included in a source code and characteristic values observable during execution of the scopes, and to acquire first attribute information obtained by aggregating the characteristic values of a plurality of pieces of scope identification information identifying the scopes; a specifier configured to specify at least one of the pieces of the scope identification information from the first attribute information; and an extractor configured to extract, from the trace information, information corresponding to the specified piece of the scope identification information.

### CROSS-REFERENCE TO RELATED APPLICATIONS

This application is based upon and claims the benefit of priority from Japanese Patent Application No. 2015-162817, filed on Aug. 20, 2015; the entire contents of which are incorporated herein by reference.

### FIELD

Embodiments described herein relate generally to system, a method, and a program product for trace information management.

### BACKGROUND

Trace information constituted by characteristic values observable during execution of a source code (program) and an execution sequence thereof is used for various purposes. The trace information is used for, for example, verification of the source code and visualization of execution states of the source code. Techniques for dealing with the trace information include a technique in which data and metadata of the trace information are separately stored, and identification information as information for linking the data and the metadata is added to a set of a probe and a user in the source code.

The amount of trace information varies with, for example, the size of the source code and a granularity set when the trace information is generated. For example, a larger size of the source code or a finer granularity increases the amount of trace information. The trace information includes information unnecessary for the purpose of use thereof, in some cases.

In conventional techniques, when certain processing is performed using acquired trace information, the trace information having a granularity set at generation thereof is used without modification. In other words, if the granularity of the trace information is finer than that necessary for the purpose of use of the trace information, the trace information as acquired needs to be referred to even with, for example, unnecessary information included therein. Due to his, if the amount of trace information is very large, a system performing the intended processing is subjected to an excessively large processing load, so that problems arise, such as a reduction in an operational efficiency.

### BRIEF DESCRIPTION OF THE DRAWINGS

FIG. 1 is a diagram illustrating a functional configuration of a trace information management system in a first embodiment;

FIG. 2 is a diagram illustrating a hardware configuration of the trace information management system;

FIG. 3 is a diagram illustrating a source code in the first embodiment;

FIG. 4 is a diagram illustrating trace information in the first embodiment;

FIG. 5 is a diagram illustrating attribute information in the first embodiment;

FIG. 6 is a diagram illustrating extracted information in the first embodiment;

FIG. 7 is a flowchart illustrating processing by the trace information management system in the first embodiment;

FIG. 8 is a diagram illustrating a source code in a second embodiment;

FIG. 9 is a diagram illustrating trace information , the second embodiment;

FIG. 10 is a diagram illustrating tree structure information representing branching relations among scopes;

FIG. 11 is a diagram illustrating first attribute information in the second embodiment;

FIG. 12 is a diagram illustrating second attribute information in the second embodiment;

FIG. 13 is a diagram illustrating first extracted information generated based on information specified from the first attribute information;

FIG. 14 is a diagram illustrating second extracted information generated based on information specified from the second attribute information; and

FIG. 15 is a diagram illustrating a relation between a calling relation between functions and cycle numbers.

### DETAILED DESCRIPTION

### First Embodiment

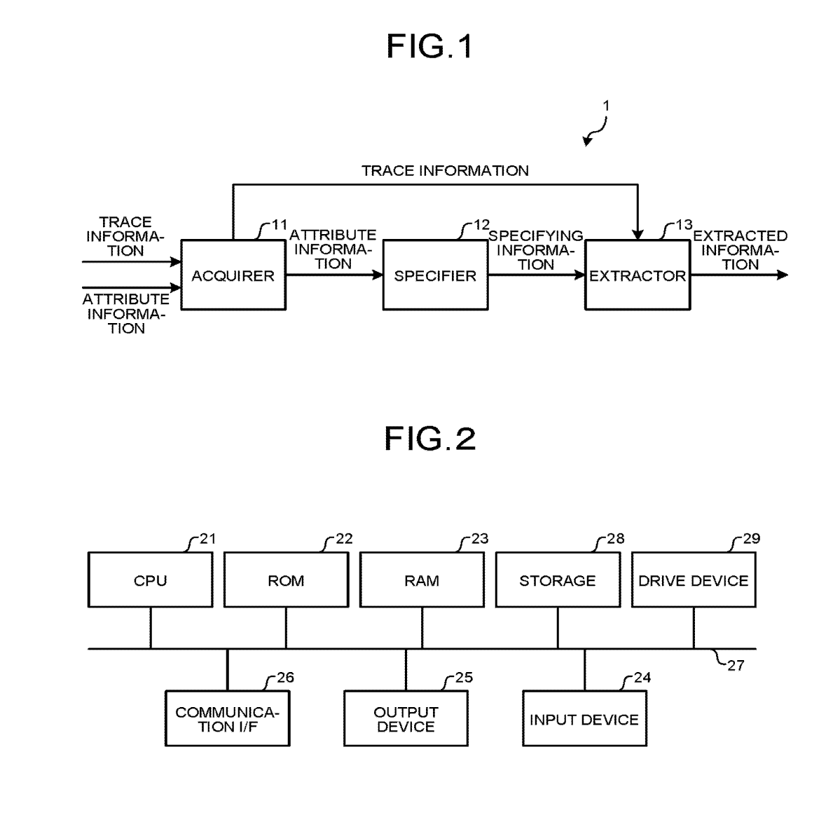

FIG. 1 is a diagram illustrating a functional configuration of a trace information management system 1 in a first embodiment. The trace information management system 1 includes an acquirer 11, a specifier 12, and an extractor 13.

FIG. 2 is a diagram illustrating a hardware configuration of the trace information management system 1. The trace information management system 1 includes a central processing unit (CPU) 21, a read only memory (ROM) 22, a random access memory (RAM) 23, an input device 24, an output device 25, a communication interface (I/F) 26, a bus 27, a storage 28, and a drive device 29. The CPU 21 follows a program stored in, for example, the ROM 22 or the storage 28 to execute predetermined arithmetic processing, using, for example, the RAM 23 or the storage 28 as a working area. The input device 24 is a device to receive information from the outside, and includes, for example, a keyboard, a mouse, and/or a touchscreen panel. The output device 25 is a device to output internally generated information to the outside, and includes, for example, a display and/or a printer. The communication I/F 26 is a device that enables transmission and reception of information to and from external devices through a network. The drive device 29 is connectable with a detachable recording medium, and can at least read out data from the recording medium.

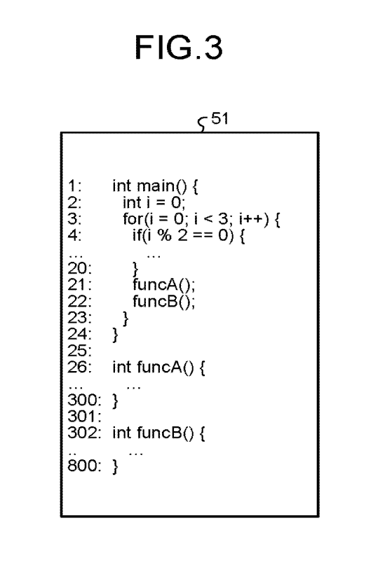

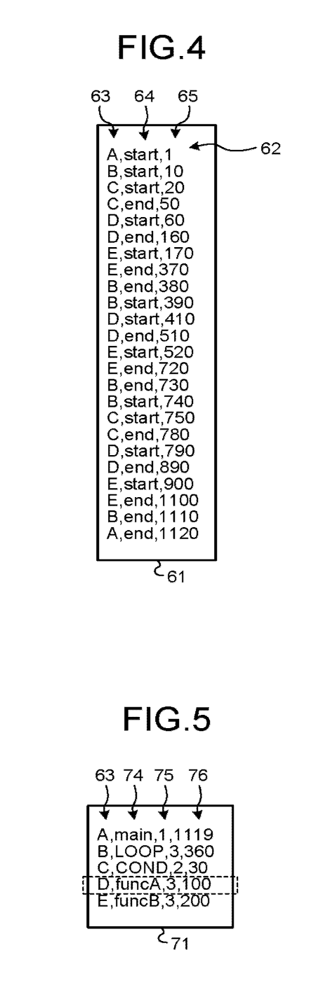

The acquirer 11 acquires trace information and attribute information. FIG. 3 is a diagram illustrating a source code 51 serving as a base for the trace information. FIG. 4 is a diagram illustrating trace information 61. FIG. 5 is a diagram illustrating attribute information 71.

The trace information 61 is generated based on the source code 51, and includes characteristic values observable during execution of the source code 51 and an execution sequence of the source code 51. The characteristic values are information indicating behaviors that have occurred during the execution of the source code 51, and are, for example, time when a scope started and time when the scope ended. The characteristic values are not limited to these examples. The scope is a range defined in the source code and is a range corresponding to, for example, a portion put in braces { }, such as a function (main, funcA, or funcB), a conditional statement (if), or a loop statement (for). The way of defining the scope is not limited to these examples. The definition can be appropriately made in accordance with the form of the source code 51. The scope may be defined, for example, by specifying any continuous section in the source code 51 using, for example, a file name or line numbers. Alternatively, a special language-neutral control structure for this system may be embedded in the source code 51 or a binary code compiled therefrom, and the scope may be defined based on the timing of start and end of the structure. One scope may include one or more scopes.

In the source code 51 illustrated in FIG. 3, the number given at the head of each line is a line number used for description. A colon (:) divides the line number from the body of the source code 51. Although the source code 51 of this example is a pseudo-code mimicking the notation of the C language, the programming language of the source code is not limited to this example. In the example of FIG. 3, the function main is defined from line 1 to line 24, the function funcA is defined from line 26 to line 300, and the function funcB is defined from line 302 to line 800. A variable i is defined on line 2, and a loop statement (for) with the variable i as a loop variable and processing in the loop statement block are defined from line 3 to line 23. The code from line 4 to line 20 defines a conditional statement (if) and processing in the conditional statement block executed when a remainder obtained by dividing the variable i by 2 is 0. A loop count is defined to be 3 on line 3. In the loop, the function funcA is defined to be executed on line 21, and the function funcB is defined to be executed on line 22. That is, the functions funcA and funcB are each called and executed three times during the loop. In this process, the case occurs twice in which a remainder obtained by dividing the variable i by 2 is 0 (case in which the variable i is 0 or 2). That is, the processing in the conditional statement block from line 4 to line 20 executed twice.

The trace information 61 illustrated in FIG. 4 is an example of information acquired as a result of the execution of the source code 61 illustrated in FIG. 3. The trace information 61 includes a plurality of records 62. Each of the records 62 includes a scope ID (scope identification information) 63, status information 64, and timing information 65. Each of the scope IDs 63 (A, B, C, D, and E) is a symbol uniquely set for each scope of the source code 51. In this example, “A” corresponds to the “function main”, “B” to the processing put in the braces { } of the “loop statement, for”, “C” to the processing put in the braces { } of the “conditional statement, if”, “D” t the “function funcA”, and “E” to the “function funcB”. The status information 64 (start or end) indicates a status of each scope at certain timing. In this example, start indicates that a scope has started, and end indicates that the scope has ended. The timing information 65 is a numerical value indicating timing when the status information 64 has reached the indicated status. This numerical value indicates the execution sequence of the source code 51, and represents the number of instruction-execution cycles (number of clocks) in this example, but may represent, for example, time or an elapsed time. The execution sequence is not limited to being represented by the information included in the trace information 61, but may be represented, for example, by an arrangement order of the records 62 included in the trace information 61. The status information 64 and the timing information 65 indicate the start timing and the end timing of each scope.

In the trace information 61 illustrated in FIG. 4, “A,start,1” on the first line indicates that the function main has started at the first cycle. “B,start,10” on the second line indicates that the processing in the loop statement block from line 3 to line 23 of the source code 51 has started at the 10th cycle. “C,start,20” on the third line indicates that the processing in the conditional statement block from line 4 to line 20 of the source code 51 has started at the 20th cycle. “C,end,50” on the fourth line indicates that the processing in the conditional statement block from line 4 to line 20 of the source code 51 has ended at the 50th cycle. Subsequently, the execution sequence of the respective scopes is listed in the same manner.

The attribute information 71 indicates the characteristic values of the scopes, scope by scope. Each of the characteristic values of the scopes is a value indicating the characteristic of the scope, such as an execution count and an execution period (such as the number of instruction-execution cycles or the elapsed time) of the scope. The characteristic value of the scope is not limited to these examples.

The attribute information 71 illustrated in FIG. 5 is information in a tabular form obtained by aggregating the characteristic values acquired from the trace information 61 illustrated in FIG. 4 on a scope-by-scope basis. The attribute information 71 of this example includes the scope IDs 63, scope names 74, execution count information 75, and average execution period information 76. The scope IDs 63 in the attribute information 71 is the same as the scope IDs 63 in the trace information 61. Each of the scope names 74 is information verbally expressing a name or an abbreviated name of a scope corresponding to the scope ID 63. The execution count information 75 indicates the numbers of times at which the respective scopes are executed during the entire period indicated by the trace information 61. The average execution period information 76 indicates average execution periods each for one execution of the scope.

In the attribute information 71 illustrated in FIG. 5, “A,main,1,1119” on the first line indicates that the scope ID 63 “A” represents the function main, the function main is executed once in the entire period, and the average execution period thereof is 1119 cycles. “B,LOOP,3,360” on the second line indicates that the scope ID 63 “B” represents the loop statement (processing in the “for” loop statement block from line 3 to line 23 of the source code 51), the loop statement is executed three times in the entire period, and the average execution period for one execution is 360 cycles. “C,COND,2,30” on the third line indicates that the scope ID 63 “C” represents the conditional statement (processing in the “if” conditional statement block from line 4 to line 20 of the source code 51), the conditional statement is executed twice in the entire period, and the average execution period for one execution is 30 cycles. “D,funcA,3,100” on the fourth line indicates that the scope ID 63 “D” represents the function funcA, the function funcA is executed three times in the entire period, and the average execution period for one execution is 100 cycles. “E,funcB,3,200” on the fifth line indicates that the scope ID 63 “E” represents the function funcB, the function funcB is executed three times in the entire period, and the average execution period for one execution is 200 cycles.

By using the information, such as the attribute information 71 described above, obtained by aggregating the characteristic values scope ID 63 by scope ID 63, the entire trace information 61 can be overviewed. In this example, the number of the records 62 of the trace information 61 is not so large. However, if the number of the records 62 is tens of thousands hundreds of millions, the overall picture of the trace information 61 is very difficult to be understood. In such cases, using the attribute information 71 as described above enables precise understanding of the overall picture of the trace information 61.

The acquirer 11 is configured using, for example, the CPU 21, a control program, logic integrated circuits (ICs), and the RAM 23. The term “acquire” as used herein includes receiving data from the outside and internally generating data. In other words, the trace information 61 and the attribute information 71 may be generated by a system (device other than the trace information management system 1, or may be generated in the trace information management system 1. The method for generating the trace information 61 and the attribute information 71 is not limited. The trace information 61 and the attribute information 71 only need to be appropriately generated using a known or new technique.

The source code 51 as a target of acquisition by the acquirer 11 may be written in a programming language unique to a particular processing unit. The source cod 51 may be a result of conversion, for example, into a binary form that has been compiled, for example, by some kind of compiler device and is executable on a particular computer device, into an intermediate expression form used in the compiler device or the computer device, or into a form of an assembly language or the like. The source code 51 may be, for example, an application program that operates under an environment of some kind of operating system or the like, a program that serves as an operating system or an infrastructure system, or a program that serves as a device driver or the like for operating hardware. The source code 51 need not necessarily be one file containing all information, but may include a plurality of files corresponding to a plurality of pieces of divided information. In this manner, the source code 51 only needs to have a form that allows generation of the trace information 61 using a known or new technique.

The trace information 61 may include, as information on the characteristic values, information on, for example, how many times of memory access have occurred at the timing when a record 62 was previously generated and at the timing when a section of a function or t like in the source code 51 ended, which memory was accessed, how much memory was used at what timing, when the memory was allocated, and when the memory was freed. The trace information 61 may include information on a file name and a line number indicating a location in the source code 51 where a behavior related to a characteristic value has occurred, and on a path and a server indicating a location where the source code 51 is present. The trace information 61 may include names given to regions defined by surrounding continuous sections of the source code 51 with block-like structures of the programming language. The trace information 61 may include information identifying a version of the source code 51 using, for example, an ID assigned to each particular section and an ID issued in a source code management system. The trace information 61 may include IDs each of which is uniquely given each time the record 62 is generated. The trace information 61 can include any number of pieces of information on the characteristic values. A plurality of pieces of the trace information 61 may be obtained as a result of executing a plurality of times the same source code 51 under different conditions. In this manner, the trace information 61 only needs to be generated so as to include information on the various characteristic values using a known or new technique.

The specifier 12 specifies at least one of the scope IDs 63 from the attribute information 71 acquired. Information indicating the specified scope ID (or IDs) 63 is output from the specifier 12 as specifying information used for extraction processing by the extractor 13. The specifier 12 is configured using, for example, the CPU 21, a control program, logic ICs, the output device (such as the display), and the input device (such as the keyboard, the mouse, and/or the touchscreen panel). For example, a user may specify desired one or more of the scope ID 63 from the attribute information 71 displayed on the display of the computer. The CPU 21 may perform processing to automatically specify a scope or copes having characteristic values (such as the execution count and the execution period) satisfying predetermined conditions. In this manner, at least one of the scope IDs 63 only needs to be specified from the attribute information 71 using a known or new technique.

The extractor 13 generates extracted information by extracting information corresponding to the specified scope ID (or IDs) 63 from the trace information 61 based on the specifying information output from the specifier 12.

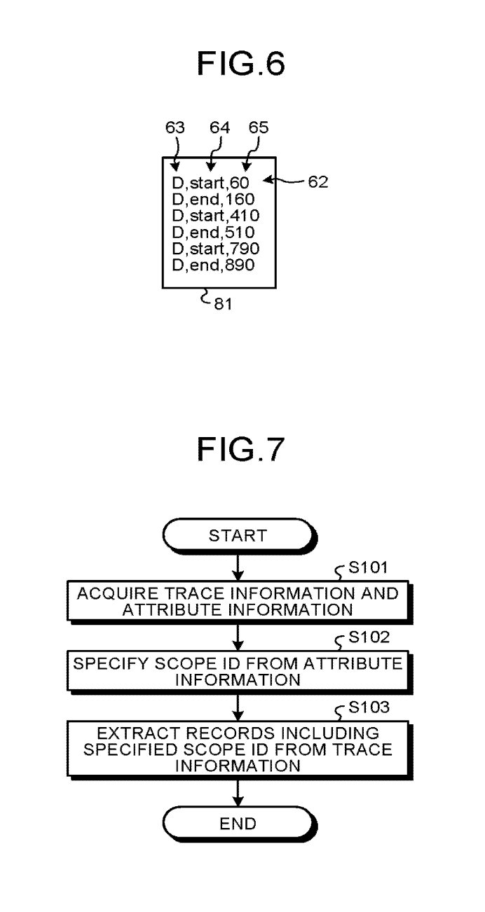

FIG. 6 is a diagram illustrating extracted information 61. The extracted information 81 of this example is an example in which the scope ID 63 “D” indicating the function funcA is specified from the attribute information 71 illustrated in FIG. 5. The extracted information 81 is information generated by extracting only records 62 including the scope ID 63 “D” from th trace information 61 illustrated in FIG. 4. While the number of records 62 included in the trace information 61 illustrated in FIG. 4 is 24, the number of records 62 included in the extracted information 81 illustrate in FIG. 6 is 6. In this manner, the processing of the extractor 13 can narrow the number of records 62 down to a half or less.

The extractor 13 is configured using, for example, the CPU 21, a control program, and logic ICs. As described above, when a scope ID 63 is specified from the attribute information 71, records 62 including the scope ID 63 are extracted from the trace information 61. The processing to extract the records 62 from the trace information 61 can be performed by appropriately using a known or new search algorithm. The method for creating the extracted information 81 in the extractor 13 is not limited the example described above. For example, instead of removing unnecessary records 62, a mark such as a flag may be added to each of the records 62 including the specified scope ID 63 so as to be able to identify desired records 62 when the extracted information 81 is used. The records 62 may be extracted not only from one piece of trace information 61, but also from a plurality of pieces of trace information 61, and the extracted records 62 may be grouped on a piece-by-piece basis of the trace information 61. The records 62 extracted from all pieces of trace information 61 may be grouped together into one group.

Using the trace information management system 1 described above can facilitate examination of, for example, a problematic part. Storing a large amount of information on the characteristic values in the trace information 61 enables finding of changes in the characteristic values related to a problem during the execution of the program, and further enables extraction, cause analysis, and correction of the problematic part. However, increase in the amount of the trace information 61 makes it difficult to detect the problematic part from the trace information 61. Thus, using first the attribute information 71 in which the characteristic values are aggregated scope ID 63 by scope ID 63, characteristic values related to the problem to be solved are examined. For example, when a certain function is executed a million times, and another function is executed ten times, the trace information 61 stores therein a million and ten pieces of information at each of the start and the end of the function, so that two million and twenty records 62 are generated. It is very difficult to detect the problem while checking all the records 62. However, by using the attribute information 71 to understand that the problem is likely to lie in the function executed only ten times, and by specifying the scope ID 63 corresponding to the function, the number of records 62 included in the extracted information 61 results in 20, so that the number of targets of the examination can be greatly reduced. Then, close examination of the characteristic values stored in the twenty records 62 enables examination f whether the problem always occurs or only occurs during executions at certain timing, and thus enables easy attainment of more detailed information leading to extraction, cause analysis, and correction of the problematic part.

The extracted information 81 generated as described above can be used for various purposes. The extracted information 81 may be output without modification to, for example, a display of a computer, and may be provided to other systems, such as a system for verifying the source code 51 and a system for visualizing execution states of the source code 51.

FIG. 7 is a flowchart illustrating processing by the trace information management system 1 described above. First, the acquirer 11 acquires the trace information 61 and the attribute information 71 (S101). Then, the specifier 12 specifies a scope ID 63 corresponding to a scope to be extracted from the attribute information 71 (S102). Then, the extractor 13 extracts records 62 including the specified scope ID 63 from the trace information 61, and generates the extracted information 81 (S103).

The hardware configuration illustrated in FIG. 2 is merely an example. The trace information management system 1 can be implemented in various hardware configurations. For example, the acquirer 11, the specifier 12, and extractor 13 can be implemented by a stand-alone general-purpose computer, a dedicated device having a built-in processor, or an interactive system in which user terminals are connected to a server through the Internet or the like.

Although FIG. I illustrates the configuration in which the acquirer 11, the specifier 12, and extractor 13 serving as the most basic functional blocks of the trace information management system 1 are connected in the order of processing, embodiments are not limited to this configuration. The embodiments may have, for example, a configuration in which the functional blocks operate in parallel in cooperation with one another, a configuration in which the order of the functional blocks are interchanged with one another, a configuration in which each of the functional blocks is divided into a plurality of blocks, or a combined configuration of these three configurations.

A program that carries out the functions of the trace information management system 1 can be recorded on a computer-readable recording medium, such as a CD-ROM, a flexible disk (FD), a CD-R, or a DVD, as a file in an installable format or an executable format, and can be provided, for example, via the drive device 29. The program may be provided by being downloaded from a certain storage device connected to a network to a certain computer, or may be provided to a certain information processing device by being incorporated in a ROM or the like in advance. The program may be constituted by a plurality of modules for performing the above-described functions of the acquirer 11, the specifier 12, and extractor 13.

According to the trace information management system 1 described above, a granularity of the trace information 61 can be changed from that at the time of acquisition of the trace information 61 by using the attribute information 71 obtained by aggregating the characteristic values for each scope ID 63 for identifying a scope. This makes it easier to understand the overall picture of the trace information 61 with a very large amount of information, and enables efficient extraction of necessary information from the trace information 61.

### Second Embodiment

The following describes a second embodiment with reference to the drawings. The same reference numerals will be assigned to the same or similar parts as or to those of the first embodiment, and the description thereof will not be repeated in some cases.

The first embodiment has illustrated the configuration in which the granularity of the trace information 61 is adjusted based on the scope ID 63. The second embodiment will illustrate a configuration in which the granularity of trace information is adjusted further based on calling relations among a plurality of scopes.

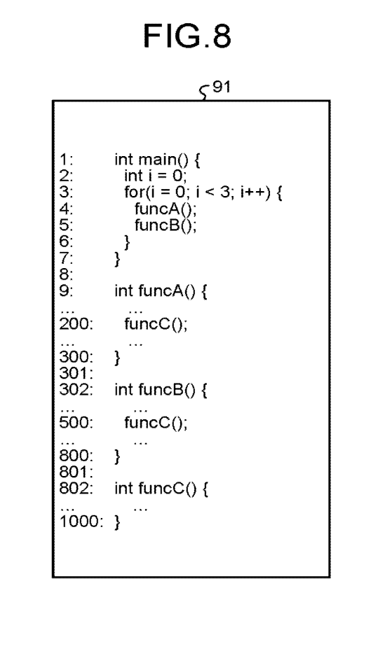

FIG. 8 is a diagram illustrating a source code 91 in the second embodiment. In the source code 91 of this example, the function main is defined from line 1 to line 7, the function funcA is defined from line 9 to line 300, the function funcB is defined from line 302 to line 800, and a function funcC is defined from line 802 to line 1000. The variable i is defined on line 2, a loop introduced by a for statement with the variable i as a loop variable is defined from line 3 to line 6, and a loop count is defined to be 3 on line 3. In the loop, the function funcA is defined to be executed on line 4, and the function funcB is defined to be executed on line 5. That is, the functions funcA and funcB are each called and executed three times during the loop. The function funcC is defined to be executed on line 200 in the function funcA and on line 500 in the function funcB. The functions funcA and funcB are each executed three times, so at the function funcC is executed six times.

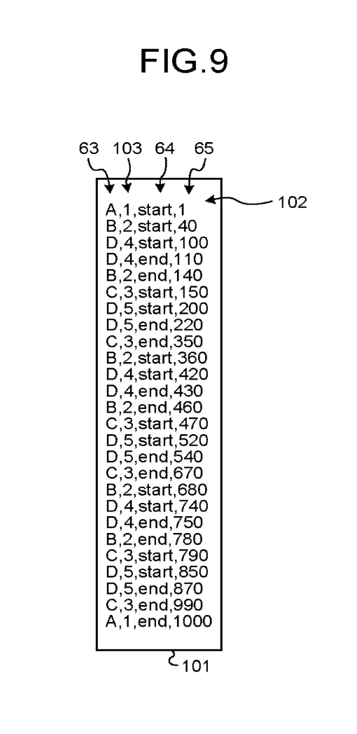

FIG. 9 is a diagram illustrating trace information 101 in the second embodiment. The trace information 101 illustrated in FIG. 9 is an example of information acquired as a result of the execution of the source code 91 illustrated in FIG. 8. The trace information 101 includes a plurality of records 102. Each of the records 102 includes the scope ID 63, a calling relation ID (calling relation identification information) 103, the status information 64, and the timing information 65. The record 102 in the second embodiment differs from the record 62 in the first embodiment in including the calling relation ID 103.

Each of the scope IDs 63 (A, B, C, and D) in the second embodiment is a symbol uniquely set for each function in the source code 91. “A” corresponds to the “function main”, “B” to the “function funcA”, and “C” to the “function funcB”, and “D” to the “function funcC”. That is, in the present embodiment, the scope ID 63 is not assigned to processing in statement blocks(such as loop statement blocks and conditional statement blocks) other than the functions. Such a way of assignment of the scope ID 63 is merely an example, and the embodiments need not be limited to this example.

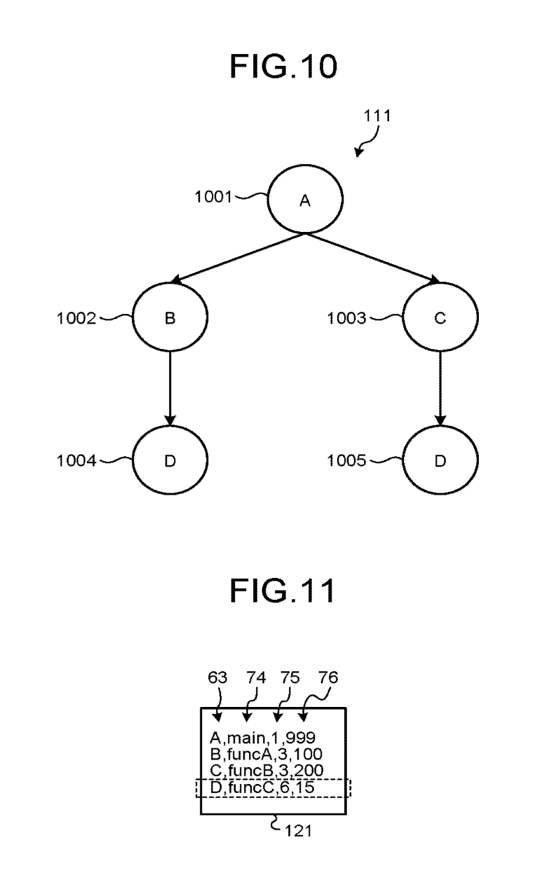

The calling relation IDs 103 “1” to “5” illustrated in FIG. 9 indicate calling relations of the functions A “main” B “funcA”, C “funcB”, and D “funcC”. FIG. 10 is a diagram illustrating tree structure information 111 representing calling relations among scopes (functions). The tree structure information 111 of this example includes five nodes 1001 to 1005. The symbols A to D marked for the nodes 1001 to 1005 correspond to the scope IDs 63 A to D, respectively, in FIG. 9.

The nodes 1001 to 1003 of the tree structure information 111 indicate that the functions funcA and funcB are called from the function main. The nodes 1002 and 1004 indicate that the function funcC is called from the function funcA. The nodes 1003 and 1005 indicate that the function funcC is called from the function funcB.

The calling relation IDs 103 “1” to “5” included in the records 102 illustrated in FIG. 9 correspond to the nodes 1001 to 1005, respectively, of the tree structure information 111 illustrated in FIG. 10. Specifically, the calling relation ID 103 “1” corresponds to the node 1001 (scope ID 63 “A”, that is, the function main); the calling relation ID 103 “2” corresponds to the node 1002 scope ID 63 “B”, that is, the function funcA); the calling relation ID 103 “3” corresponds to the node 1003 (scope ID 63 “C”, that is, the function funcB); the calling relation ID 103 “4” corresponds to the node 1004 (scope ID 63 “D”, that is, the function funcC); and the calling relation ID 103 “5” corresponds to the node 1005 (scope ID 63 “D”, that is, the function funcC).

In the trace information 101 illustrated in FIG. 9, “A,1,start,1” on the first line indicates that the function main that corresponds to the node 1001 in the tree structure information 111 and is called first of all has started at the first cycle. “B,2,start,40” on the second line indicates that the function funcA that corresponds to the node 1002 in the tree structure information 111 and is called from the function main has started at the 40th cycle. “D,4,start,100” on the third line indicates that the function funcC that corresponds to the node 1004 in the tree structure information 111 and is called from the function funcA has started at the 100th cycle. “D,4,end,110” on the fourth line indicates that the function funcC that corresponds to the node 1004 in the tree structure information 111 and is called from the function funcA has ended at the 110th cycle. “B,2,end,140” on the fifth line indicates that the function funcA that corresponds to the node 1002 in the tree structure information 111 and is called from the function main has ended at the 140th cycle. Subsequently, the execution sequence of the respective functions is listed in the same manner.

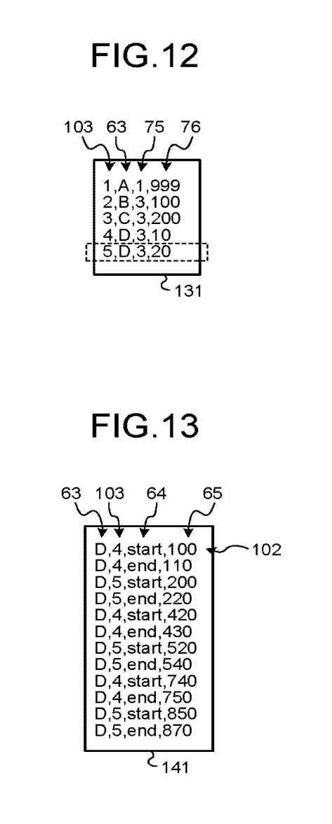

FIG. 11 is a diagram illustrating first attribute information 121 in the second embodiment. FIG. 12 is a diagram illustrating second attribute information 131 in the second embodiment.

The first attribute information 121 illustrated in FIG. 11 includes the scope IDs 63, the scope names 74, the execution count information 75, and the average execution period information 76. These pieces of information included in the first attribute information 121 are substantially the same as those in the attribute information 71 in the first embodiment illustrated in FIG. 5.

The second attribute information 131 illustrated in FIG. 12 includes the calling relation IDs 103, the scope IDs 63, the execution count information 75, and the average execution period information 76. As described above, the calling relation IDs 103 “1” to “5” correspond to the nodes 1001 to 1005, respectively, of the tree structure information 111 illustrated in FIG. 10.

The second attribute information 131 of this example specifically indicates the following states. “1,A,1,999” on the first line indicates that the node 1001 corresponding to the function main (scope ID 63 “A”) called first is executed once in the entire period, and the average execution period thereof is 999 cycles. “2,B,3,100” on the second line indicates that the node 1002 corresponding to the function funcA (scope ID 63 “B”) called from the function main is executed three times in the entire period, and the average execution period for one execution is 100 cycles. “3,C,3,200” on the third line indicates that the node 1003 corresponding to the function funcB (scope ID 63 “C”) called from the function main is executed three times in the entire period, and the average execution period for one execution is 200 cycles. “4,D,3,10” on the fourth line indicates that the node 1004 corresponding to the function funcC (scope ID 63 “D”) called from the function funcA is executed three times in the entire period, and the average execution period for one execution is 10 cycles. “5,D,3,20” on the fifth line indicates that the node 1005 corresponding to the function funcC (scope ID 63 “D”) called from the function funcB is executed three times in the entire period, and the average execution period for one execution is 20 cycles.

In the second attribute information 131 described above, the value of the average execution period information 76 differs between the fourth line and the fifth line. Hence, it is found that the same function funcC changes in behavior in accordance with the caller (the function funcA or the function funcB). Such a determination is made not only by information indicated in “D,funcC,6,15” on the fourth line of the first attribute information 121.

The information stored in the first attribute information 121 and the second attribute information 131 is not limited to information obtained by aggregating the characteristic values in the scopes and the nodes 1001 to 1005. The scopes or the nodes 1001 to 1005 overlap when, for example, a scope calls another scope. In such a case, information other than that of target scopes or target nodes can be ignored by ignoring the overlapped information, or by specifying th depth or relativity of the calling relation. For example, considered is a case in which the function funcB is called from the function funcA as illustrated in FIG. 15. In an example illustrated in FIG. 15, the function funcA is executed from the 100th cycle to the 600th cycle. Thus, if a value from th start cycle to the end cycle is simply employed, the number of execution cycles results in 500 cycles. However, the processing of the function funcA itself is not performed during a period of time while the function funcB is called, so that this per d of time is desired to be omitted in some cases. In the example illustrated in FIG. 15, the function funcB is executed from the 200th cycle to the 400th cycle, resulting in a number of execution cycles of 200 cycles. To obtain an actual number of execution cycles of the function funcA, the number of execution cycles of the function funcB need to be subtracted. Thus, the actual number of execution cycles of the function funcA results in 300 cycles. In this manner, in addition to the simple aggregation of the information on the characteristic values, unnecessary information may be ignored. The first attribute information 121 and the second attribute information 131 may include information indicating o which files and to which lines the target scopes or the target nodes correspond. In addition, the first attribute information 121 and the second attribute information 131 each may store information associable with the scope ID 63 and the calling relation ID 103 even if the information has no direct relation with the information on the characteristic values stored in each of the records 102 of the trace information 101. For example, the second attribute information 131 may store information, such as a depth of the tree structure and the number of nodes. In this manner, as long as certain information on the characteristic values is associable with the scope ID 63 and the calling relation ID 103, the content of the information on the characteristic values stored in the first attribute information 121 and the second attribute information 131 does not matter.

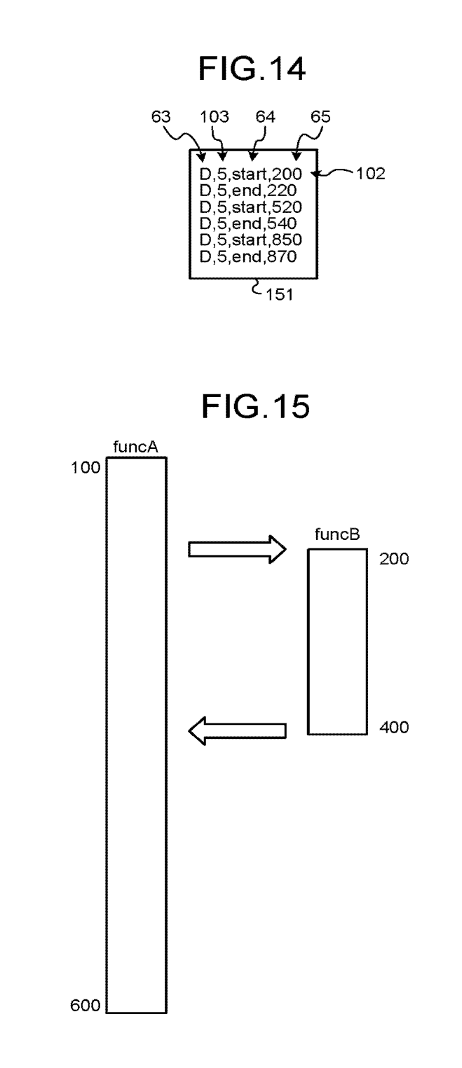

The specifier 12 in the present embodiment uses both the first attribute information 121 and the second attribute information 131 to generate the specifying information used for the extraction processing by the extractor 13. FIG. 13 is a diagram illustrating first extracted information 141 generated based on information specified from the first attribute information 121. FIG. 14 is a diagram illustrating second extracted information 151 generated based on information specified from the first attribute information 121 and the second attribute information 131. Each of the records 102 of the first extracted information 141 and the second extracted information 151 includes the scope ID 63, the calling relation ID 103, the status information 64, and the timing information 65.

The first extracted information 141 illustrated in FIG. 13 is an example in which the scope ID 63 “D” (function funcC) is specified from the first attribute information 121 illustrated in FIG. 11. The first extracted information 141 is information generated by extracting the records 102 including the scope ID 63 “D” from the trace information 101 illustrated in FIG. 9. While the number of records 102 included in the trace information 101 illustrated in FIG. 9 is 26, the number of records 102 included in the first extracted information 141 illustrated in FIG. 13 is 12. In this manner, the processing of the extractor 13 can narrow the number of records 102 down to a half or less.

The second extracted information 151 illustrated in FIG. 14 is an example in which the calling relation 119 103 “5” is specified from the second attribute information 131 illustrated in FIG. 12. The second extracted information 151 is information generated by extracting the records 102 including the calling relation ID 103 “5” from the trace information 101 illustrated in FIG. 9. While the number of records 102 included in the trace information 101 illustrated in FIG. 9 is 26, the number of records 102 included in the second extracted information 151 illustrated in FIG. 14 is 6. In this manner, the processing of the extractor 13 can narrow the number of records 102 down to a half or less.

For example, a problematic part can be more easily examined by use of the trace information management system 1 in the present embodiment. For example, considered is a case in which a function has been executed a million times, during which the function has been called from three functions of a function A, a function B, and a function C, 800000 times, 199990 times, and 10 times, respectively. In this case, the trace information 101 stores information obtained at the starts and ends of the million executions of the functions, and all pieces of the information serve as information indicating the results of the executions of the functions. Due to this, two million records 62 remain in the first extracted information 141, resulting in an insufficient narrowing of the information. However, using the calling relation IDs 103 can classify the million executions into three types based on callers of the functions. Thus, the extracted information (second extracted information 151) with the number of records 102 narrowed down to 20 can be generated by using the attribute information (second attribute information 131) aggregated for each calling relation ID 103 to understand that a problem is likely to lie, for example, in the ten executions called by the function C, and by specifying the calling relation ID 103 corresponding to the function. As a result, the number of targets of the examination can be greatly reduced. Then, close examination of the characteristic values stored in the 20 records 102 enables examination of whether the problem always occurs or only occurs during executions at certain timing, and thus enables easy attainment of more detailed information leading to extraction, cause analysis, and correction of the problematic part.

The first extracted information 141 and the second extracted information 151 generated in this manner can be used for various purposes in the same manner as the extracted information 81 in the first embodiment.

As described above, th granularity of the trace information 101 can be more effectively adjusted by extracting the desired information (records 102) from the trace information 101, using the first attribute information 121 created based on the information (scope IDs 63) for identifying the scopes, and also using the second attribute information 131 created based on the information (calling relation IDs 103) for identifying the calling locations in the tree structure information 111.

In this manner, using the attribute information created based on the various types of information enables understanding of the characteristics of the trace information (source code) from every point of view, and enables an increase in the degree of freedom of the granularity adjustment.

While certain embodiments have been described, these embodiments have been presented by way of example only, and are not intended o limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A trace information management system comprising:
an acquirer configured to acquire trace information indicating an execution sequence of a plurality of scopes included in a source code and characteristic values observable during execution of the scopes, and to acquire first attribute information obtained by aggregating the characteristic values of a plurality of pieces of scope identification information identifying the scopes;
a specifier configured to specify at least one of the pieces of the scope identification information from the first attribute information; and
an extractor configured to extract information corresponding to the specified piece of the scope identification information from the trace information.

2. The trace information management system according to claim 1, wherein
the trace information includes a plurality of records indicating start times and end times of the respective scopes,
the records include the scope identification information, and
the extractor extracts, from the trace information, the records including the scope identification information specified by the specifier.

3. The trace information management system according to claim 1, wherein
the acquirer further acquires second attribute information obtained by aggregating the characteristic values of calling relation identification information indicating a calling relation between the scopes,
the specifier further specifies at least one piece of the calling relation identification information from the second attribute information, and
the extractor further extracts, from the trace information, information corresponding to the specified piece of the calling relation identification information.

4. The trace information management system according to claim 3, wherein
the trace information includes a plurality of records indicating start times and end times of the respective scopes,
the records include the calling relation identification information, and
the extractor extracts, from the trace information, the records including the calling relation identification information specified by the specifier.

5. The trace information management system according to claim 1, wherein the characteristic values are execution periods of the scopes.

6. The trace information management system according to claim 1, wherein the characteristic values are execution counts of the scopes.

7. The trace information management system comprising:
a server; and
an information processing terminal configured to connect to the server through a network, wherein
the server acquires trace information indicating an execution sequence of a plurality of scopes included in a source code and characteristic values observable during execution of the scopes, and first attribute information obtained by aggregating the characteristic values of a plurality of pieces of scope identification information identifying the scope,
the information processing terminal specifies at least one of the pieces of the scope identification information from the first attribute information, and transmits the specified piece of the scope identification information to the server, and
the server extracts information corresponding to the specified piece of the scope identification information from the trace information.

8. A method for trace information management, the method comprising:
acquiring trace information indicating an execution sequence of a plurality of scopes included in a source code and characteristic values observable during execution of the scopes, and acquiring first attribute information obtained by aggregating the characteristic values of a plurality of pieces of scope identification information identifying the scopes;
specifying at least one of the pieces of the scope identification information from the first attribute information; and
extracting, from the trace information, information corresponding to the specified piece of the scope identification information.

9. A trace information management program product having a non-transitory computer readable medium including a program causing a computer to execute:
acquiring trace information indicating an execution sequence of a plurality of scopes included in a source code and characteristic values observable during execution of the scopes, and acquiring first attribute information obtained by aggregating the characteristic values of a plurality of pieces of scope identification information identifying the scopes;
specifying at least one of the pieces of the scope identification information from the first attribute information; and
extracting, from the trace information, information corresponding to the specified piece of the scope identification information.
